(19) United States
(12) Patent Application Publication
(10) Pub. No.: US 2013/0196678 A1
(43) Pub. Date: Aug. 1, 2013

(54) SCHEDULING METHOD AND SYSTEM FOR COORDINATED MULTIPOINT TRANSMISSION/RECEPTION

(71) Applicants: Le Liu, Tokyo (JP); Takamichi Inoue, Tokyo (JP); Yoshikazu Kakura, Tokyo (JP)

(72) Inventors: Le Liu, Tokyo (JP); Takamichi Inoue, Tokyo (JP); Yoshikazu Kakura, Tokyo (JP)

(73) Assignee: NEC CORPORATION, Minato-ku, Tokyo (JP)

(21) Appl. No.: 13/824,464

(22) PCT Filed: Oct. 7, 2010
(86) PCT No.: PCT/JP2010/006013

§ 371 Date: Mar. 18, 2013

(51) Int. Cl. H04W 72/04

(52) U.S. Cl. CPC H04W 72/04
USPC 455/452.1

(57) ABSTRACT

A scheduling system for coordinated user equipments (UEs) in a network including a plurality of communicating points which can communicate with each other, wherein the coordinated UEs are supported by a serving point and are coordinated with a neighbor point, is characterized in that the serving point and the neighbor point share information related to an available or desired amount of resources for coordinated UEs of the serving point; and the serving point adjusts at least one predetermined parameter related to the coordinated UEs based on the shared information so that the amount of resources for the coordinated UEs at the serving point approaches the available or desired amount of resources for the coordinated UEs at the neighbor point.

### TECHNICAL FIELD

The present application relates generally to a wireless communications system and, more specifically, to a method and system of scheduling resources for coordinated multi-point transmission/reception (CoMP).

### BACKGROUND ART

In the early 3rd Generation Partnership Project (3GPP) Long Term Evolution (LTE) study item, it has been decided that data is only allocated to a serving cell in order to simplify its implementation, where the serving cell is the cell transmitting physical downlink control channel (PDCCH) assignments as indicated in Section 8.1.1 of NPL 1.

Recently, LTE-Advanced (LTE-A) standard has being developed for 4th generation system (4G), where the fairly aggressive target in system performance requirements have been defined, particularly in terms of spectrum efficiency for both downlink (DL) and uplink (UL) as indicated in Section 8 of NPL 2. Considering the target of cell-edge user throughput and average cell throughput, which is set to be roughly much higher than that of LTE Release-8, it seems that the coordinated transmission is necessarily included as a major candidate among LTE-A techniques. Coordinated multi-point transmission/reception (CoMP) is considered as a tool to improve the coverage of high data rates, the cell-edge throughput and/or to increase system throughput in both high load and low load scenarios (see Section 8 of NPL 1).

According to 3GPP LTE-A study item discussion, joint processing (JP) and coordinated scheduling/beamforming (CS/CB) have been agreed as DL CoMP categories as described in Section 8.1.1 of NPL 1. For DL CoMP JP, the data to single user equipment (UE) is shared by multiple points and simultaneously transmitted from multiple transmission points (CoMP JT: joint transmission) or transmitted from one point at a time (CoMP fast cell selection). For DL CoMP CS/CB, data is only transmitted by the serving cell but user scheduling/beamforming decisions are made with coordination among cooperating points. On the other hand, UL CoMP reception can involve joint reception (JR) of the transmitted signal at multiple reception points and/or coordinated scheduling (CS) decisions among points to control interference as described in Section 8.2 of NPL 1. Here, the cooperating point can be base station, eNode-B (eNB) connected by X2 backhaul, cell, or other type of node, such as remote radio equipment (RRE) or distributed antenna connected by optical fiber (see NPL 3). Hereinafter, the term “CoMP UE” is used to represent a UE which has more than one cooperating point and a UE with only one cooperating point, i.e., serving point, is regarded as “non-CoMP UE”.

FIG. 1 shows an example of DL CoMP JT, where a UE 103 is a CoMP UE that belongs to a serving cell 101 and also receives data from a cooperating cell 102. A UE 104 is a non-CoMP UE, which is served by the cell 101. The serving cell 101 and cooperating cell 102 are connected by an X2 backhaul connection 105, which is used for information exchange.

For LTE-A DL CoMP JT, dynamic channel-dependent scheduling is carried out to tentatively allocate resources for a CoMP UE by using short-term channel state information (CSI) at both its serving cell and its cooperating cell, but only assign common resources for the CoMP UE at the serving cell and cooperating cell (e.g. NPL 3 and PTL 1). In channel-dependent scheduling, the resource is allocated for the UE which has highest CSI.

As shown in FIGS. 2 and 3 based on the description of NPL 3, the serving cell 101 semi-statically decides CoMP UE(s) based on long-term-measured reference signal received power (RSRP) (step 110). Thereafter, the dynamic channel-dependent scheduling for CoMP is performed to tentatively allocate resources for the CoMP UE 103 based on short-term CSI and, among tentative allocated RBs for the CoMP UE 103, only common RBs are allocated at both the serving cell 101 and the cooperating cell 102 (step 111). In this example, as shown in FIG. 3, common resource blocks (RBs) #0 and #4 are allocated for the CoMP UE 103.

{NPL 1} 3GPP TR 36.814 (V9.0.0), “Further Advancements for E-UTRA Physical Layer Aspects,” http://www.3gpp.org/ftp/Specs/archive/36_series/36.814/.
{NPL 2} 3GPP TR 36.913 v9.0.0, Requirements for further advancements for Evolved Universal Terrestrial Radio Access (E-UTRA) (LTE-Advanced), December 2009. http://www.3gpp.org/ftp/Specs/archive/36_series/36.913/.
{NPL 3} R1-091484, NTT DOCOMO, “Evaluation of DL CoMP Gain Considering RS Overhead for LTE-Advanced”, 3GPP TSG RAN WG1 Meeting #56bis, Seoul, Korea, Mar. 23-27, 2009.

### {PTL 1} JP2010-154262A

### SUMMARY

### Technical Problem

In the above-mentioned scheduling scheme, common RBs are allocated at both the serving cell 101 and the cooperating cell 102. In other word, twice RBs are allocated to a CoMP UE at the price of the RB for the UE served by the cooperating cell 102, but the throughput of a CoMP UE may be improved less than twice of the throughput before using CoMP. If the serving cell 101 chooses too many CoMP UEs in the case where a lot of UEs are waiting to be served by the cooperating cell 102, the cooperating cell 102 has to sacrifice the resources of its own UEs. The cooperating cell's UEs, even including some UEs close to cell-edge, suffer from user throughput degradation due to the loss of resources. As a result, the average cell throughput as well as cell-edge user throughput is reduced due to the employment of CoMP.

An object of the present invention is to provide scheduling method and system for CoMP, which can determine the amount of resources to be allocated for CoMP UEs without loss of the resources for UEs served by the cooperating cell.

### Solution to Problem

According to the present invention, a scheduling system for coordinated user equipments (UEs) in a network including a plurality of communicating points which can communicate with each other, wherein the coordinated UEs are supported by a serving point and are coordinated with a neighbor point, is characterized in that the serving point and the neighbor point share information related to an available or desired amount of resources for the coordinated UEs of the serving point; and the serving point adjusts at least one predetermined parameter related to the coordinated UEs based on the shared information so that the amount of resources for the coordinated UEs at the serving point approaches the available or desired amount of resources for the coordinated UEs at the neighbor point.

According to the present invention, a scheduling method for coordinated user equipments (UEs) in a network including a plurality of communicating points which can communicate with each other, wherein the coordinated UEs are supported by a serving point and are coordinated with a neighbor point, is characterized by: sharing information related to an available or desired amount of resources for the coordinated UEs of the serving point between the serving point and the neighbor point; and at the serving point, adjusting at least one predetermined parameter related to the coordinated UEs based on the shared information so that the amount of resources for the coordinated UEs at the serving point approaches the available or desired amount of resources for the coordinated UEs at the neighbor point.

According to the present invention, a communicating point which can communicate with other communicating points in a network, wherein the communicating point allocates resources to coordinated user equipments (UEs) which are supported by the communicating point as a serving point and are coordinated with a neighbor point, includes: a communication section for sharing with the neighbor point information related to an available or desired amount of resources for the coordinated UEs of the communicating point; and a scheduler for adjusting at least one predetermined parameter related to the coordinated UEs based on the shared information so that the amount of resources for the coordinated UEs at the communicating point approaches the available or desired amount of resources for the coordinated UEs at the neighbor point.

### Advantageous Effects of Invention

According to the present invention, the amount of resources for the CoMP UEs at the serving cell and cooperating cell can be determined without loss of the resources for UEs served by the cooperating cell, optimizing the CoMP gain in terms of average cell throughput and cell-edge user throughput.

For a more complete understanding of the present disclosure and its advantages, reference is now made to the following description taken in conjunction with the accompanying drawings, in which like reference numerals represent like parts.

### BRIEF DESCRIPTION OF DRAWINGS

FIG. 1 is a diagram showing an example of downlink (DL) CoMP joint transmission (JT) system.

FIG. 2 is a flowchart showing a scheduling procedure for CoMP disclosed in NPL 3.

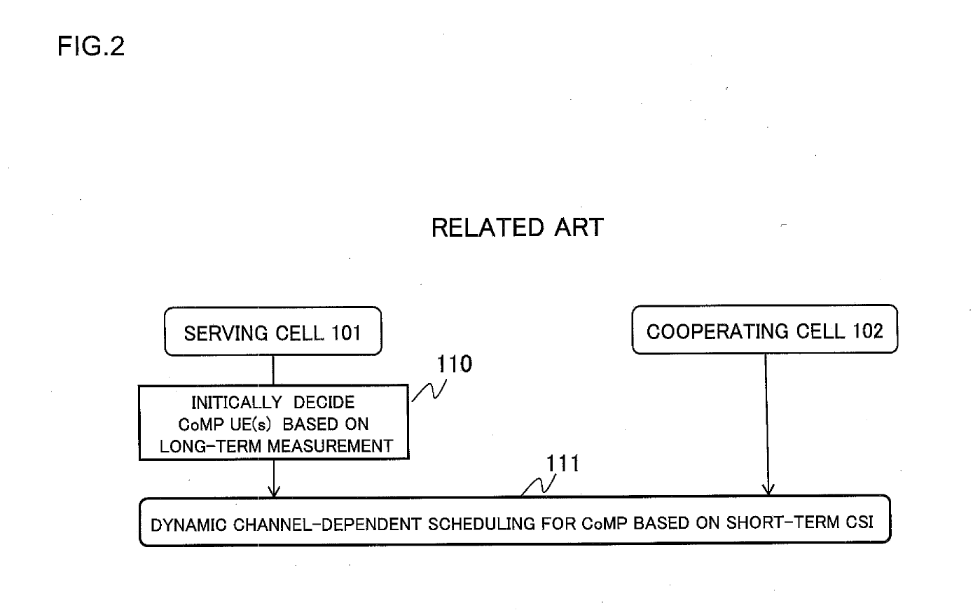

FIG. 3 is a diagram showing an example of allocated resource blocks for CoMP UE as disclosed in NPL 3.

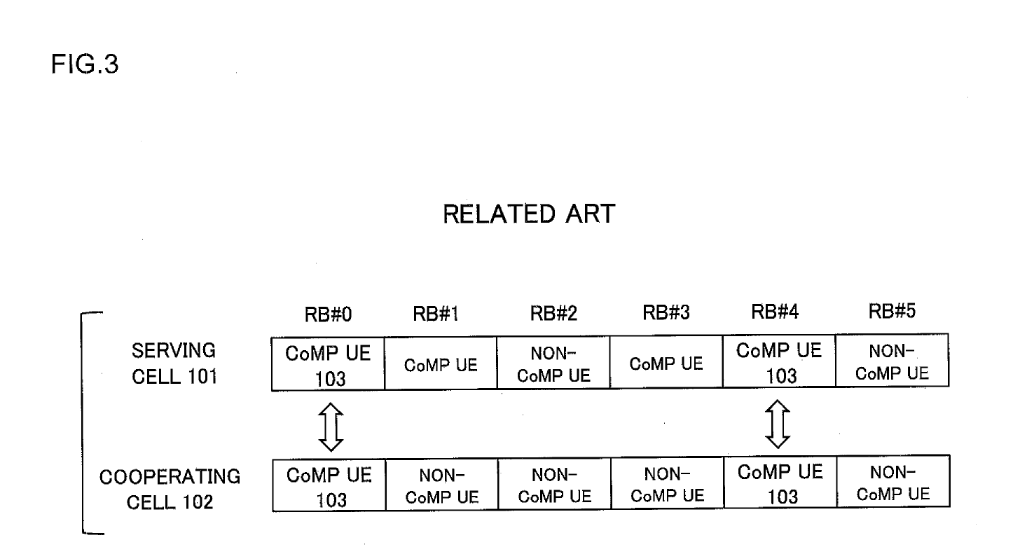

FIG. 4 is a schematic block diagram illustrating an eNB processor of a base station implementing a scheduling method according to an exemplary embodiment of the present invention.

FIG. 5 is a schematic flowchart showing a scheduling procedure for CoMP according to the present invention.

FIG. 6 is a flowchart showing a scheduling method for CoMP according to an exemplary embodiment of the present invention.

FIG. 7 is a graph showing an example of deciding CoMP UEs using CoMP threshold.

FIG. 8 is a schematic diagram showing a first example of allocated resource adjustment in the scheduling method according to the exemplary embodiment of the present invention.

FIG. 9 is a schematic diagram showing a second example of allocated resource adjustment in the scheduling method according to the exemplary embodiment of the present invention.

FIG. 10 is a flowchart showing a scheduling method for CoMP according to a first example of the present invention.

FIG. 11 is a flowchart showing a scheduling method for CoMP according to a second example of the present invention.

FIG. 12 is a flowchart showing a scheduling method for CoMP according to a third example of the present invention.

FIG. 13 is a flowchart showing a scheduling method for CoMP according to a fourth example of the present invention.

FIG. 14 is a flowchart showing a scheduling method for CoMP according to a fifth example of the present invention.

### DETAILED DESCRIPTION OF PREFERRED EMBODIMENTS

The preferred embodiments in the present invention will be explained by making references to the accompanied drawings.

### 1. Exemplary Embodiment

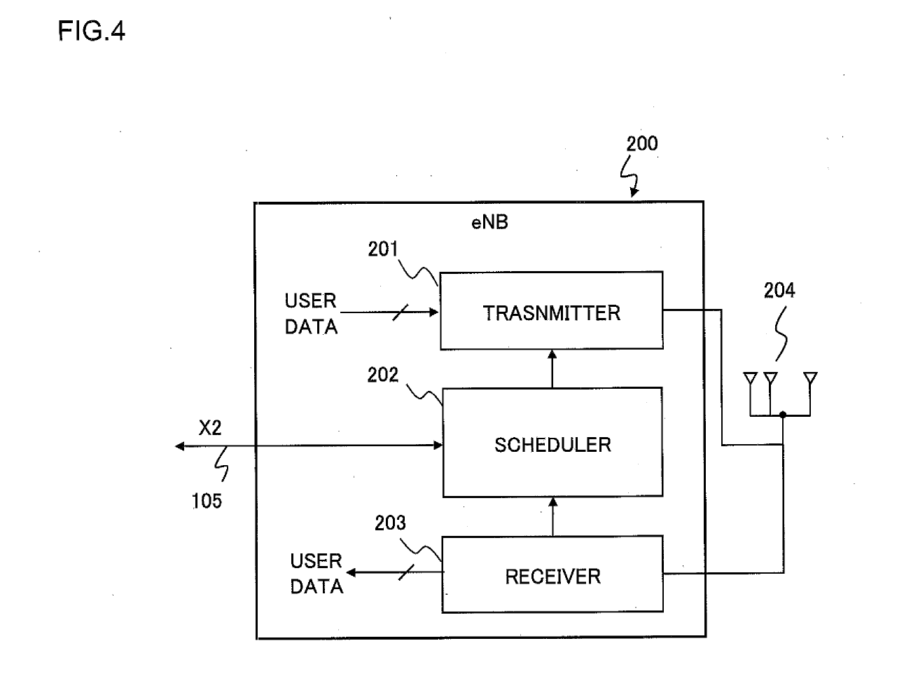

Referring to FIGS. 4 through 14, the exemplary embodiment of the present invention will be described by way of illustration only and should not be construed in any way to limit the scope of the disclosure. Those skilled in the art will understand that the principles of the present disclosure may be implemented in any suitably arranged wireless network.

As shown in FIG. 4, each cell is controlled by an eNB processor 200 including a transmitter 201, a scheduler 202, a receiver 203 and a transceiver antenna 204. The scheduler 202 is in charge of resource allocation and link adaptation for each UE. Based on the scheduling result, the UE's data at transmitter 201 is transmitted over physical downlink shared channel (PDSCH) through antenna 204. On the other hand, the UE's uplink data over physical uplink shared channel (PUSCH) is received at receiver 203. As described later, the scheduler 202 performs the cooperated scheduling according to the present exemplary embodiment to allocate resources for CoMP UEs, which are supported by its serving point and coordinated with a cooperating point. The scheduler 202 also performs the dynamic channel-dependent scheduling based on the channel state information (CSI) fed back from UEs. It should be noted that the scheduler 202 may be implemented by running a program on a program-controlled processor such as central processing unit (CPU). The program is stored in a recording medium such as a semiconductor memory, magnetic recording medium or the like (not shown). The program may be downloaded into the recording medium through a network.

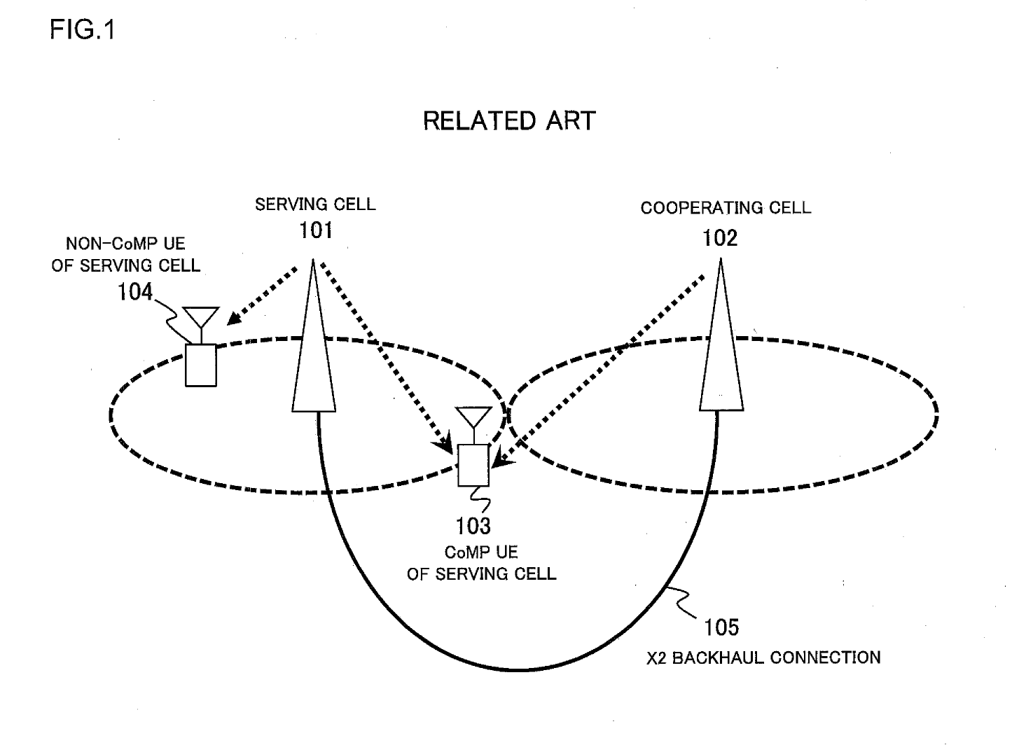

Hereinafter, the serving cell 101 and the cooperating cell 102 as shown in FIG. 1 will be referred to for explanation of the present embodiment. In this case, the information exchange between the eNB processor 200 of the serving cell 101 and that of the cooperating cell 102 is performed over the X2 backhaul connection 105. In the description of the present application, a cell is a communicating point or may be another type of communicating point such as base station, eNode-B (eNB) connected by X2 backhaul, remote radio equipment (RRE) or distributed antenna connected by optical fiber, etc. Further, resources can be frequency-domain resource blocks (RBs), time-domain RBs, spatial transmit streams, transmit power or their combinations, etc.

### 1.1) Outline of Cooperated Scheduling Scheme

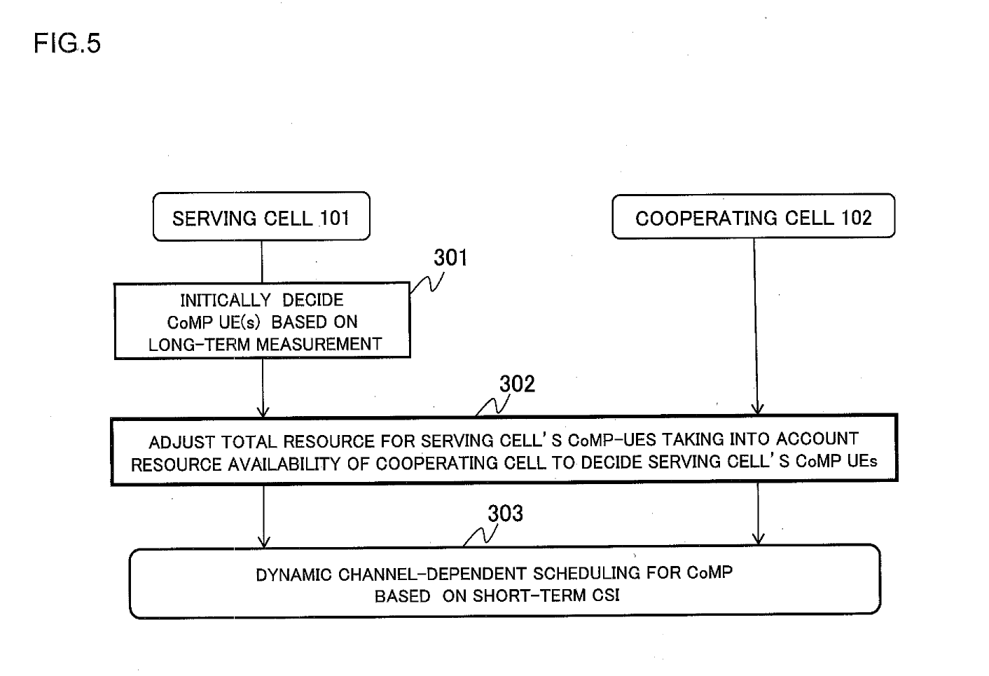

As shown in FIG. 5, at first, the scheduler 202 of the serving cell 101 initially decides CoMP UEs based on long-term measurement without considering the resource utilization of cooperating cell 102 (step 301).

Thereafter, the scheduler 202 of the serving cell 101 adjusts the total amount of resources for serving cell's CoMP UEs taking into account the resource utilization of the cooperating cell 102 and decides the serving cell's CoMP UEs based on the finally adjusted total amount of resources (step 302). More specifically, information related to the available or desired amount of resources for the CoMP UEs is shared between its serving cell 101 and cooperating cell 102. Based on the shared information, the serving cell 101 adjusts predetermined parameter(s) of CoMP to make the amount of resources for its CoMP UEs approach the available or desired amount of resources at the cooperating cell 102 to be assigned to the CoMP UEs. Such a predetermined parameter may be a CoMP threshold of long-term-measured reference signal received power (RSRP) or reference signal received quality (RSRQ) as described later, a proportional fairness (PF) for CoMP UEs, or other parameter enabling to adjust the total amount of resources for serving cell's CoMP UEs.

When the serving cell's CoMP UEs have been decided, detailed resource allocation for CoMP UEs is carried out by the dynamic channel-dependent resource allocation using short-term CSI (step 303). Note that a long-term period is 120 ms, 240 ms, 1 sec or so and a short-term period is 1 ms, 5 ms, 10 ms, 20 ms or so.

### 1.2) Cooperated Scheduling

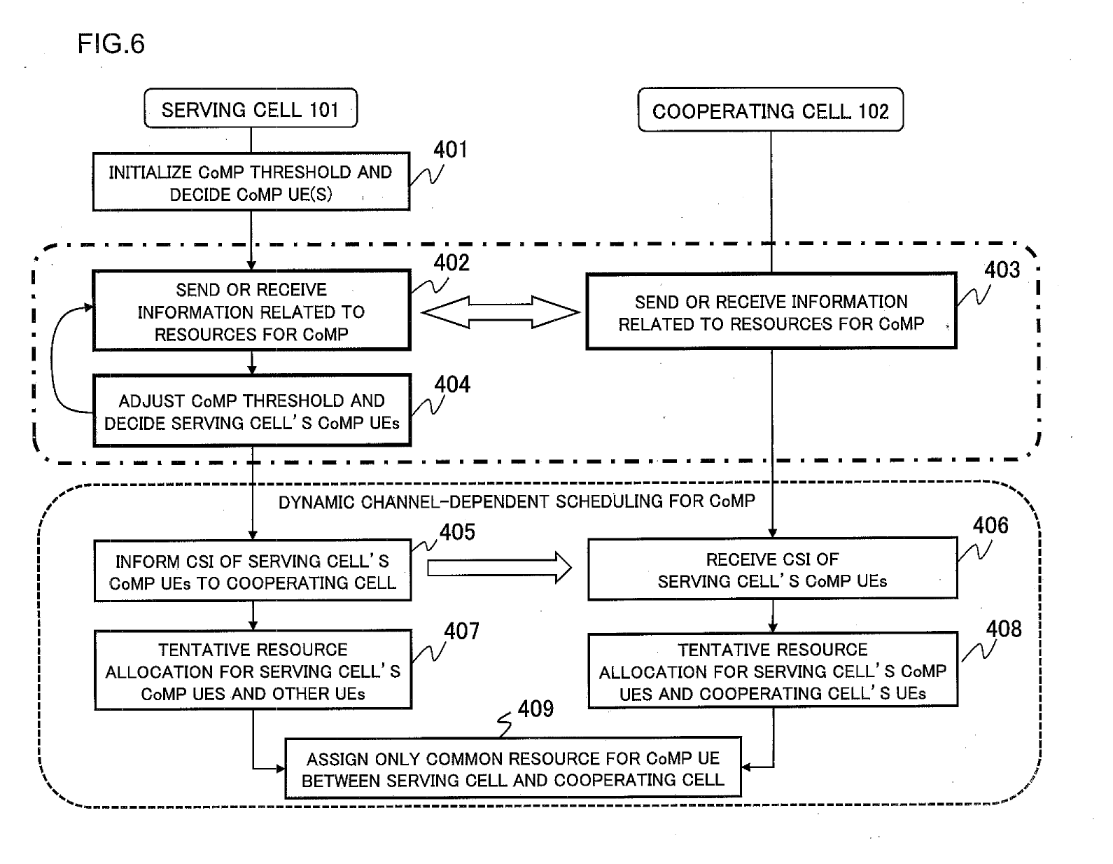

Referring to FIG. 6, the scheduler 202 of the serving cell 101 decides a CoMP threshold for recognizing CoMP UEs without considering the resource utilization of cooperating cell 102 (step 401). Thereafter, the schedulers of the serving cell 101 and cooperating cell 102 send or receive information related to the available or desired amount of resources for CoMP through the connection 105 (steps 402-403). Based on the shared information, the scheduler 202 of the serving cell 101 adjusts the CoMP threshold to change the number of CoMP UEs (step 404). In case that they do not reach an agreement, the step 402 will be repeated after step 404 until they are similar to each other. Accordingly, the amount of resource to be assigned to CoMP UEs at the serving cell 101 is close to the available or desired amount of resources at cooperating cell 102. In FIG. 6, CoMP threshold is adjusted before dynamic channel dependent scheduling, but it can be done after dynamic channel dependent scheduling.

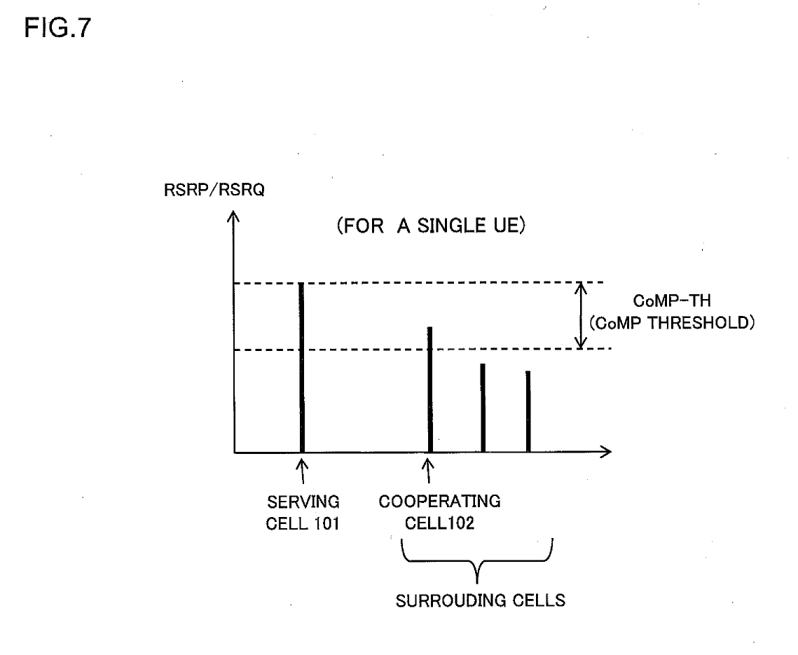

In step 401, as shown in FIG. 7, a UE can be decided as a candidate of CoMP UE when it has at least one surrounding cell providing long-term-measured reference signal received power (RSRP) or reference signal received quality (RSRQ) within the CoMP threshold (CoMP-TH) from the highest RSRP/RSRQ of the serving cell 101. If the CoMP threshold (CoMP-TH) is reduced, the present UE may become a non-CoMP UE. If the CoMP threshold (CoMP-TH) is increased, other UE(s) may become CoMP UE(s). Accordingly, the number of CoMP UEs can be changed by adjusting the CoMP threshold.

In FIG. 7, maximum two cells, whose RSRP difference relative to the serving cell's RSRP/RSRQ is within the CoMP-TH, are selected as transmission point(s), where the CoMP threshold is initialized in Step 401 at scheduler 202 of serving cell 101. A UE, who has more than one transmission point, is regarded as a CoMP UE. For UE 103, the RSRP difference between the cooperating cell 102 and serving cell 101 is within the CoMP threshold (CoMP-TH). Therefore, UE 103 is a CoMP UE and has two transmission points, serving cell 101 and cooperating cell 102. For simplifying the case, maximum number of cell is described two here, but the number of cell is not limited to two.

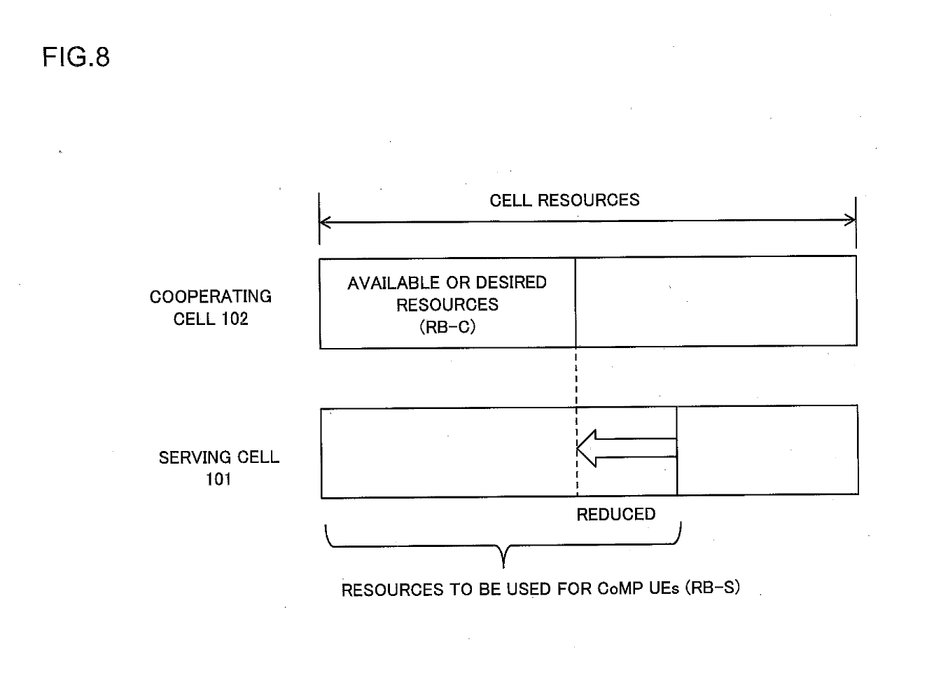

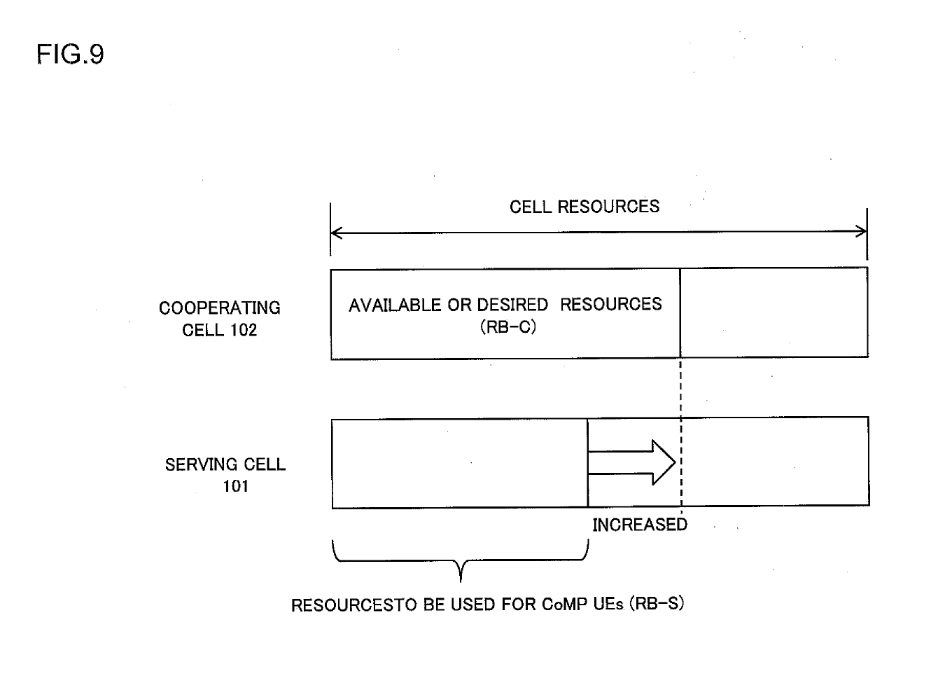

In steps 402-404, as shown in FIG. 8, in the case where the amount of resources to be used for CoMP UEs at the serving cell 101 is larger than the current amount of available or desired resources at the cooperating cell 102, the scheduler 202 of the serving cell 101 reduces the amount of resources to be used for CoMP UEs. In contrast, as shown in FIG. 9, in the case where the amount of resources to be used for CoMP UEs at the serving cell 101 is smaller than the current amount of available or desired resources at the cooperating cell 102, the scheduler 202 of the serving cell 101 increases the amount of resources to be used for CoMP UEs.

After steps 402-404, the dynamic channel-dependent resource allocation is carried out by using short-term CSI (steps 405-409) as shown in FIG. 6. More specifically, for channel-dependent scheduling, the receiver 203 of the serving cell 101 receives short-term CSI from the CoMP UE 103, the CSI including precoding vector index (PMI), rank indicator (RI) as well as channel quality information (CQI). The scheduler 202 of the serving cell 101 forwards the CSI of CoMP UE 103 to the cooperating cell 102 through the connection 105 (step 405) and the scheduler 202 of the cooperating cell 102 receives it (step 406). Thereafter, the scheduler 202 of the serving cell 101 carries out the tentative resource allocation for CoMP UE 103 as well as other serving cell's UEs, such as non-CoMP UE 104 (step 407). On the other hand, the scheduler 202 of cooperating cell 102 also tentatively allocates resource blocks (RBs) for the CoMP UE 103 and the UEs served by cooperating cell 102 itself (step 408). Among tentative allocated RBs for CoMP UE 103, only common RBs are assigned at both serving cell 101 and cooperating cell 102 (step 409).

### 1.3) Advantageous Effects

As described above, the cooperated scheduling according to the exemplary embodiment adjust the amount of resources to be used for CoMP UEs at the serving cell 101 so as not to exceed the available or desired amount of resources at the cooperating cell before detailed resource allocation for CoMP UEs according to the dynamic channel-dependent resource allocation. Therefore, the maximum amount of resources for the CoMP UEs can be allocated at the serving cell and cooperating cell without loss of the resources for UEs served by the cooperating cell, optimizing the CoMP gain in terms of average cell throughput and cell-edge user throughput.

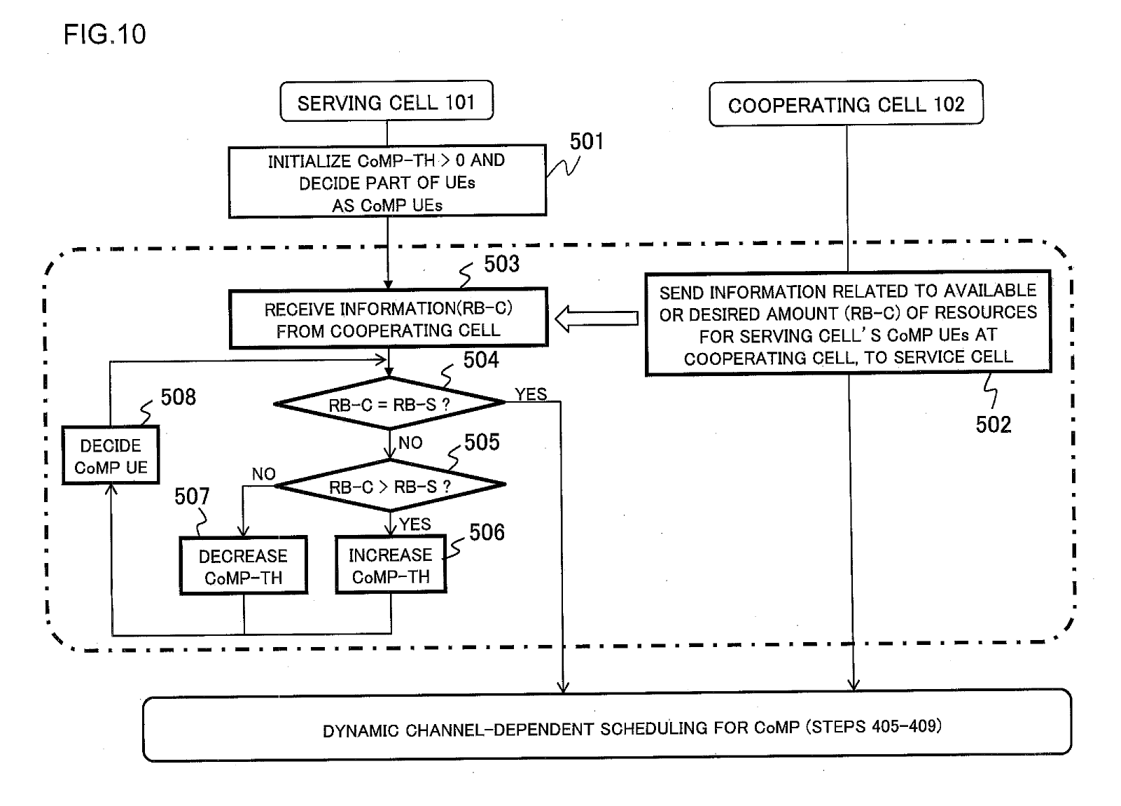

Next, examples of the cooperated scheduling will be described with references to FIGS. 10-14.

### 2. Example 1

Referring to FIG. 10, the serving cell 101 initializes the CoMP threshold (CoMP-TH>0) and decides part of the UEs belonging to the serving cell 101 as CoMP UEs (step 501). Thereafter, the scheduler 202 of the cooperating cell 102 sends information related to its available or desired amount of resources (referred to as RB-C), which can be used at cooperating cell 102 for CoMP UEs of the serving cell 101, to serving cell 101 over the connection 105 (step 502). The serving cell 101 receives the above information indicating RB-C from cooperating cell 102 (step 503).

The scheduler 202 of the serving cell 101 compares the available or desired amount of resources, RB-C, at cooperating cell 102 with the current amount of resources, RB-S, assigned to CoMP UEs at serving cell 101 (step 504). If RB-C is substantially equal to RB-S (step 504; YES), the scheduler 202 of serving cell 101 will directly go to the dynamic channel-dependent scheduling (steps 405-409). If RB-C is not substantially equal to RB-S (step 504; NO), further comparison is needed to see whether RB-C is larger than RB-S (step 505).

If RB-C is larger than RB-S (step 505; YES), the scheduler 202 of serving cell 101 increases the CoMP threshold and make more UEs become CoMP UEs (step 506 and 508) and its control goes back to step 504. If RB-C is not larger than RB-S (step 505; NO), the scheduler 202 of serving cell 101 decreases the CoMP threshold to reduce the number of CoMP UEs (step 507 and 508) and its control goes back to step 504. Accordingly, the serving cell 101 adjusts the amount of resources for its CoMP UEs until it is close to the available or desired amount of resources for the CoMP UEs at cooperating cell 102. After the adjustment at serving cell 101, the dynamic resource allocation is carried out (steps 405-409). The explanation of the steps 405-409 are omitted to avoid repetitive explanation.

### 3. Example 2

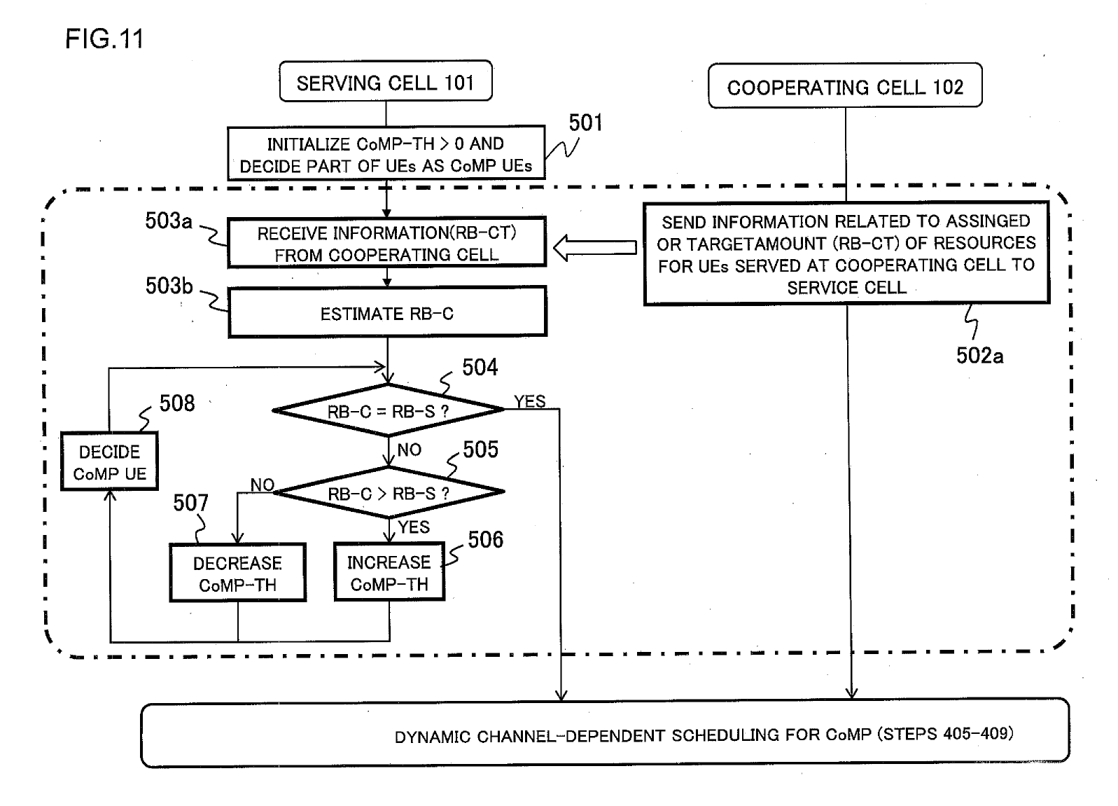

Referring to FIG. 11, the serving cell 101 initializes the CoMP threshold (CoMP-TH>0) and decides part of the UEs belonging to the serving cell 101 as CoMP UEs (step 501). Thereafter, the scheduler 202 of the cooperating cell 102 sends information related to its assigned or target amount of resources (referred to as RB-CT) for the UEs served at cooperating cell 102, to the serving cell 101 over the connection 105 (step 502a). The serving cell 101 receives the above information including RB-CT from cooperating cell 102 (step 503a).

Referring to the above information from cooperating cell 102, the scheduler 202 of the serving cell 101 estimates the available or desired amount of resources, RB-C, at cooperating cell 102 for the CoMP UEs (step 503b). To be specific, the RB-C can be estimated by subtracting RB-CT from the total amount of system resources. The steps 504-508 following the step 503b are the same as those in FIG. 10 and therefore the explanation is omitted.

### 4. Example 3

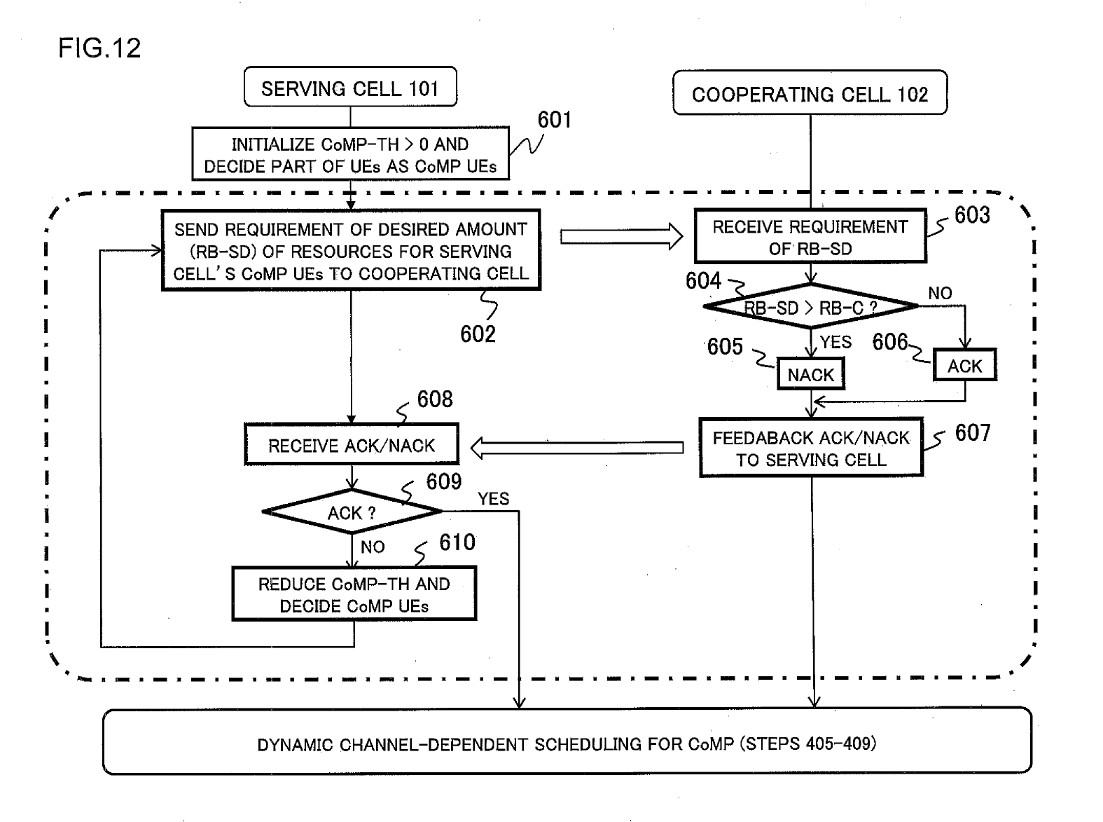

Referring to FIG. 12, the scheduler 202 of the serving cell 101 initializes the CoMP threshold (CoMP-TH>0) and decides part of the UEs belonging to the serving cell 101 as CoMP UEs (step 601). Thereafter, the scheduler 202 of the serving cell 101 firstly sends a requirement to the cooperating cell 102 over connection 105, where the requirement indicates the initially desired amount of resources (referred to as RB-SD) for CoMP UEs of the serving cell 101 (step 602). Alternatively, the requirement may indicate the number of CoMP UEs of the serving cell 101.

The cooperating cell 102 receives the above requirement from the serving cell 101 (step 603) and compares the initially desired amount of resources (or the number of CoMP UEs of the serving cell 101), RB-SD, with the available amount of resources, RB-C, at cooperating cell 102 (step 604). If RB-SD is larger than RB-C, the scheduler 202 of cooperating cell 102 makes a NACK decision (step 605); otherwise, an ACK decision (step 606). Such ACK/NACK decision will be fed back to the serving cell 101 (step 607).

The serving cell 101 receives the ACK/NACK feedback from cooperating cell 102 (step 608) and its scheduler 202 determines whether the feedback is ACK or not (step 609). If the feedback is NACK (step 609; NO), the scheduler 202 of the serving cell 101 reduces the CoMP threshold to decrease the number of CoMP UEs (step 610). The decreased number of CoMP UEs causes the decreased amount for CoMP UEs of the serving cell 101. Accordingly, the control of the scheduler 202 goes back to the step 602 to send the cooperating cell 102 another requirement representing the decreased amount of resources for CoMP UEs as the desired amount for the serving cell's CoMP UEs. If the feedback is ACK (step 609; YES), the scheduler 202 of serving cell 101 will directly go to the dynamic channel-dependent scheduling (steps 405-409). The explanation of the steps 405-409 are omitted to avoid repetitive explanation.

The process will not stop until the serving cell 101 obtains ACK from the cooperating cell 102. According to the decision of cooperating cell 102, the serving cell 101 adjusts the amount of resources for its CoMP UEs until it is close to the available amount of resources at cooperating cell 102. After the adjustment at serving cell 101, the dynamic resource allocation is carried out in steps 406-409.

In this example, the cooperating cell sends the feedback against the requirement of desired amount of resources to the serving cell, so the serving cell can know the condition of the cooperating cell directly.

In this example, the feedback from the cooperating cell is only ACK or NACK, but the information that shows the desired amount of resources in cooperating cell can be included in the feedback.

### 5. Example 4

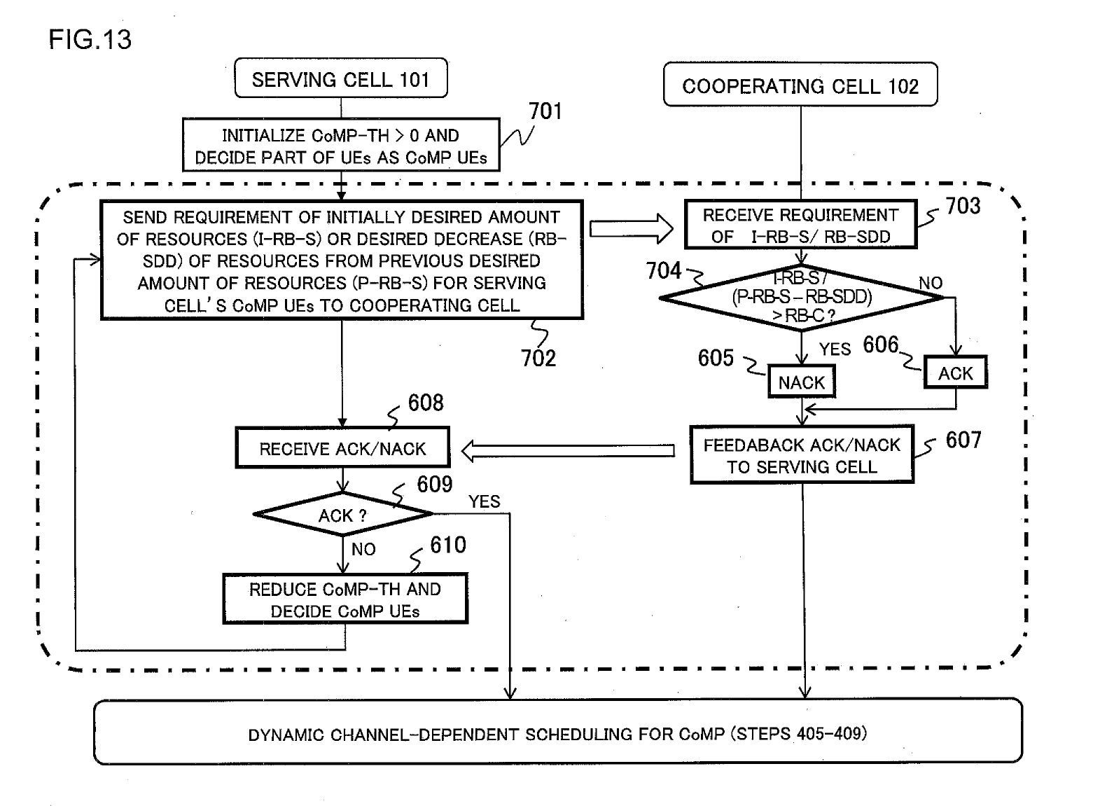

Referring to FIG. 13, the scheduler 202 of the serving cell 101 initializes the CoMP threshold (CoMP-TH>0) and decides part of UEs belonging to the serving cell 101 as CoMP UEs (step 701). Thereafter, the scheduler 202 of the serving cell 101 firstly sends a requirement to the cooperating cell 102 over connection 105, where the requirement indicates an initially desired amount of resources (indicated by I-RB-S) for the first time or a desired decrease of resources (referred to as RB-SDD) for CoMP UEs of the serving cell 101 for the subsequent requirements (step 702).

The cooperating cell 102 receives the above requirement from the serving cell 101 (step 703) and compares the available amount of resources, RB-C, at cooperating cell 102 with the initially desired amount of resources (indicated by I-RB-S) at the first time (step 704). If I-RB-S is larger than RB-C (step 704; YES), the scheduler 202 of cooperating cell 102 makes a NACK decision (step 605); otherwise, an ACK decision (step 606). Such ACK/NACK decision will be fed back to the serving cell 101 (step 607). If NACK is fed back from the cooperating cell 102 at the first time, the scheduler 202 at the serving cell 101 sends the subsequent requirement of desired decrease of resources (RB-SDD) for CoMP UEs of the serving cell 101 (step 702). The cooperating cell 102 receives the requirement of RB-SDD from the serving cell 101 (step 703) and compares the available amount of resources, RB-C, at cooperating cell 102 with the calculated desired amount of resources, which is obtained by subtracting RB-SDD from previous desired amount of resources (represented by P-RB-S) before obtaining current RB-SDD. If the desired amount of resources after considering the desired decrease of resources, i.e., (P-RB-S−RB-SDD), is larger than RB-C (step 704; YES), the scheduler 202 of cooperating cell 102 makes a NACK decision (step 605); otherwise, an ACK decision (step 606). Such ACK/NACK decision will be fed back to the serving cell 101 (step 607). The steps 605-610 following the step 704 are the same as those in FIG. 12 and therefore the explanation is omitted.

The process will not stop until the serving cell 101 obtains ACK from the cooperating cell 102. According to the decision of cooperating cell 102, the serving cell 101 adjusts the amount of resources for its CoMP UEs until it is close to the available amount of resources at cooperating cell 102. After the adjustment at serving cell 101, the dynamic resource allocation is carried out in steps 406-409.

In this example, the serving cell sends another requirement of desired amount of resources against the feedback from the cooperating cell, so the situation that CoMP UEs are not decided can be avoided.

### 6. Example 5

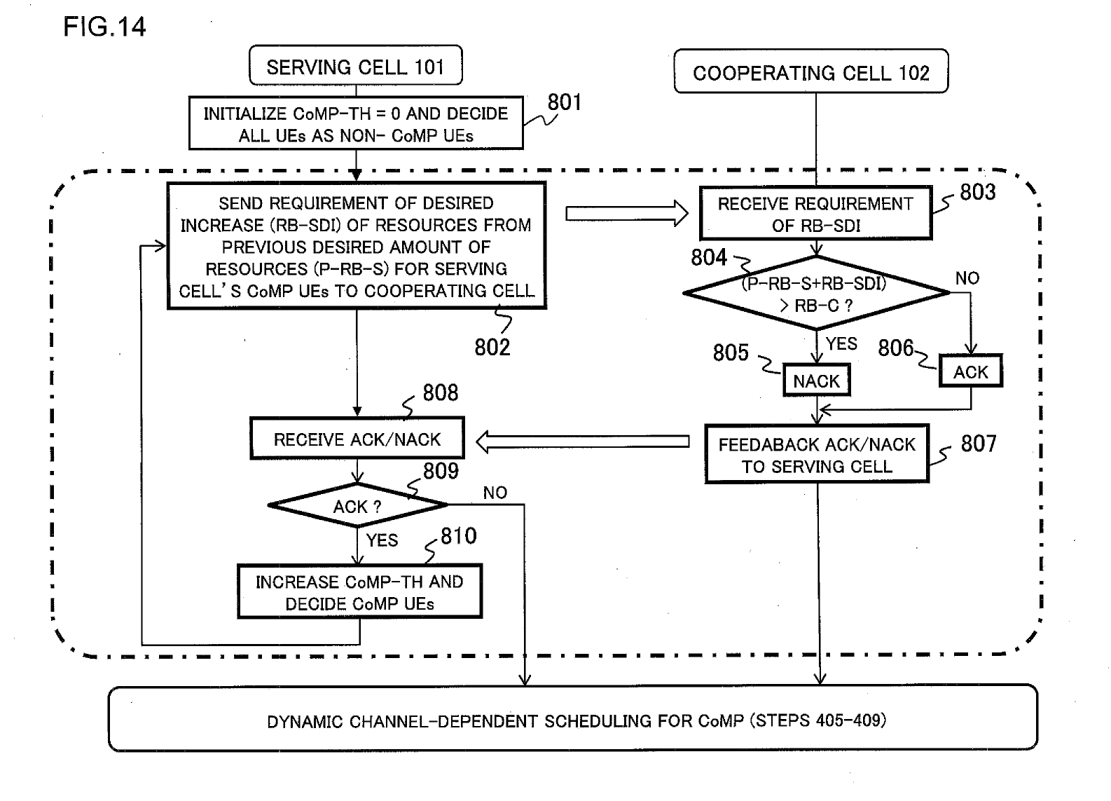

Referring to FIG. 14, the scheduler 202 of the serving cell 101 initializes the CoMP threshold (CoMP-TH=0) and decides all UEs belonging to the serving cell 101 as non-CoMP UEs (step 801). Thereafter, the scheduler 202 of the serving cell 101 firstly sends a requirement to the cooperating cell 102 over connection 105, where the requirement indicates a desired increase of resources (referred to as RB-SDI) for CoMP UEs of the serving cell 101 (step 802).

The cooperating cell 102 receives the requirement from the serving cell 101 (step 803) and compares the current available amount of resources, RB-C, at cooperating cell 102 with the calculated desired amount of resources, which is obtained by adding the increase amount of resources, RB-SDI, to the previous desired amount of resources (represented by P-RB-S) before obtaining current RB-SDI (step 804). If the desired amount of resources after considering the desired increase of resources, i.e., (P-RB-S+RB-SDI), is larger than RB-C (step 804; YES), the scheduler 202 of cooperating cell 102 makes a NACK decision (step 805); otherwise, an ACK decision (step 806). Such ACK/NACK decision will be fed back to the serving cell 101 (step 807).

The serving cell 101 receives the ACK/NACK feedback from cooperating cell 102 (step 808) and its scheduler 202 determines whether the feedback is ACK or not (step 809). If the feedback is ACK (step 809; YES), the scheduler 202 of the serving cell 101 further raises the CoMP threshold to increase the number of CoMP UEs (step 810). The increased number of CoMP UEs causes the increased amount of resources for CoMP UEs of the serving cell 101. Accordingly, the control of the scheduler 202 goes back to the step 802 to send the cooperating cell 102 another requirement representing the desired increase of resources (RB-SDI) for CoMP UEs of the serving cell 101. If the feedback is NACK (step 809; NO), the scheduler 202 of serving cell 101 will stop sending requirement but directly go to the dynamic channel-dependent scheduling (steps 405-409). The explanation of the steps 405-409 are omitted because already explained.

The process will not stop until the serving cell 101 obtains NACK from the cooperating cell 102. According to the decision of cooperating cell 102, the serving cell 101 adjusts the amount of resources for its CoMP UEs until it is close to the available amount of resources at cooperating cell 102. After the adjustment at serving cell 101, the dynamic resource allocation is carried out in steps 406-409.

In this example, the serving cell sends another requirement of desired amount of resources against the feedback from the cooperating cell, so the situation that CoMP UEs are not decided can be avoided.

### 7. Modified Examples

In the step 502 and 502a of the above Examples 1 and 2, the cooperating cell 102 may send the information related to its available or desired amount of resources to serving cell 101 periodically or a-periodically in case that the available or desired amount of resources at cooperating cell 102 changes.

In steps 602, 608, steps 702, 608 and steps 802, 808 of Examples 3, 4 and 5, the serving cell 101 may a-periodically initiate to send the requirement related to desired or available amount of resources for its CoMP UEs to the cooperating cell 102 when some UEs close to cell-edge with poor throughput performance need the employment of CoMP to improve their throughput performance, resulting in that the available or desired amount of resources for the coordinated UEs changes at the serving point.

In steps 605-607 of Examples 3 and 4 and steps 805-807 of Example 5, the feedback may include not only ACK/NACK decision but also ratio information, as reference information, indicating the ratio between the adjusted amount of resources at the serving cell 101 and the available amount of resources (RB-C) at the cooperating cell 102. In the case that the ratio information is included in the feedback, the scheduler 202 of the serving cell 101 can determine the amount of increase/decrease of CoMP threshold or other parameter enabling to adjust the amount of resources for serving cell's CoMP UEs.

If the connection between serving point and cooperating point suffers from large transmission delay, such as X2 backhaul between eNBs, it is difficult to exchange instantaneous information very frequently and therefore, the desired or available amount of resources is semi-static information, e.g., average available number of resource blocks (RBs) or RB ratio. If the connection's transmit delay is small and also its capacity permits frequent information exchange, it is also possible that the desired or available amount of resources is instantaneous information, e.g., the number of RBs or RB ratio at the previous transmit time interval (TTI).

The above-described examples illustrate the proposed scheduling scheme for DL CoMP JT. However, the present invention is not restricted to these examples. The proposed scheme can also be used for other CoMP categories, such as DL CoMP JP with fast cell selection, DL CoMP CS/CB, as well as UL CoMP JR and UL CoMP CS.

The serving cell and cooperating cell may also be other type of communicating points, such as base station, eNode-B (eNB) connected by X2 backhaul, remote radio equipment (RRE) or distributed antenna connected by optical fiber, etc. The resources mentioned in the above examples can be frequency-domain RBs, time-domain RBs, spatial transmit streams, transmit power or their combinations, etc.

Furthermore, as the parameter for adjusting the amount of resources for CoMP UEs, not only CoMP threshold but also other parameters enabling to adjust the amount of resources for serving cell's CoMP UEs or their combinations can be used, such as the number of cooperating cells, the number of CoMP UEs, the weighting factor of PF metric, etc.

### INDUSTRIAL APPLICABILITY

The present invention can be applied to the scheduler of a base station in CoMP network system.

### REFERENCE SIGNS LIST

101 serving cell
102 cooperating cell
103 CoMP UE of serving cell
104 non-CoMP UE
105 X2 backhaul connection
200 eNB processor
201 transmitter
202 scheduler
203 receiver
204 transceiver antenna

What is claimed is:

1. A scheduling system for coordinated user equipments (UEs) in a network including a plurality of communicating points which can communicate with each other, wherein the coordinated UEs are supported by a serving point and are coordinated with a neighbor point, wherein:
the serving point and the neighbor point share information related to an available or desired amount of resources for the coordinated UEs of the serving point; and
the serving point adjusts at least one predetermined parameter related to the coordinated UEs based on the shared information so that the amount of resources for the coordinated UEs at the serving point approaches the available or desired amount of resources for the coordinated UEs at the neighbor point.

2. The scheduling system as set forth in claim 1, wherein the neighbor point sends the information to the serving point, including an available or desired amount of resources for the coordinated UEs at the neighbor point.

3. The scheduling system as set forth in claim 1, wherein the neighbor point sends the information to the serving point, including an assigned or target amount of resources for UEs served by the neighbor point itself; and the serving point uses the information to estimate the available or desired amount of resources for the coordinated UEs at the neighbor point.

4. The scheduling system as set forth in claim 1, wherein the serving point sends the information to the neighbor point, including a desired amount of resources for the coordinated UEs or a number of the coordinated UEs at the serving point; and correspondingly the neighbor point sends feedback information to the serving point, including a decision which is a result of comparing an available amount of resources at the neighbor point with the desired amount of resources included in the information sent from the serving point.

5. The scheduling system as set forth in claim 1, wherein the serving point sends the information to the neighbor point, including an initially desired amount of resources at the beginning and thereafter including a desired decrease of resources from the previous desired amount of resources for the coordinated UEs at the serving point; and correspondingly the neighbor point sends feedback information to the serving point, including at the beginning a decision which is a result of comparing an available amount of resources at the neighbor point with the initially desired amount of resources included in the information sent from the serving point, and thereafter including a decision which is a result of comparing an available amount of resources at the neighbor point with the calculated desired amount of resources, which is obtained by subtracting the desired decrease of resources, included in the information sent from the serving point, from the previous desired amount of resources for the coordinated UEs.

6. The scheduling system as set forth in claim 1, wherein the serving point sends the information to the neighbor point, including a desired increase of resources for the coordinated UEs at the serving point; and correspondingly the neighbor point sends feedback information to the serving point, including a decision which is a result of comparing an available amount of resources at the neighbor point with the calculated desired amount of resources, which is obtained by adding the desired increase of resources, included in the information sent from the serving point, to the previous desired amount of resources for the coordinated UEs.

7. The scheduling system as set forth in claim 1, wherein the neighbor point periodically sends the information to the serving point.

8. The scheduling system as set forth in claim 1, wherein the neighbor point a-periodically sends the information to the serving point when the available or desired amount of resources for the coordinated UEs changes at the neighbor point.

9. The scheduling system as set forth in claim 1, wherein the serving point a-periodically sends the information to the neighbor point when the available or desired amount of resources for the coordinated UEs changes at the serving point.

10. The scheduling system as set forth in claim 1, wherein the predetermined parameter includes at least one of a threshold relative to the serving point's reference signal received power or quality for deciding coordinated UEs, a number of coordinated UEs, a number of coordinated points, and a priority weighting factor of the resource allocation metric for the coordinated UEs.

11. The scheduling system as set forth in claim 1, wherein the resource for the coordinated UEs includes at least one of a frequency-domain resource block, time-domain resource block, spatial transmit stream, and transmit power at the serving point and the neighbor point.

12. The scheduling system as set forth in claim 1, wherein each communicating point is one of a cell, a base station, a Node-B, an enhanced Node-B, a remote radio equipment and a distributed antenna.

13. A scheduling method for coordinated UEs in a network including a plurality of communicating points which can communicate with each other, wherein the coordinated UEs are supported by a serving point and are coordinated with a neighbor point, comprising:
sharing information related to an available or desired amount of resources for the coordinated UEs of the serving point between the serving point and the neighbor point; and
at the serving point, adjusting at least one predetermined parameter related to the coordinated UEs based on the shared information so that the amount of resources for the coordinated UEs at the serving point approaches the available or desired amount of resources for the coordinated UEs at the neighbor point.

14. A communicating point which can communicate with other communicating points in a network, wherein the communicating point allocates resources to coordinated UEs which are supported by the communicating point as a serving point and are coordinated with a neighbor point, comprising:
a communication section for sharing with the neighbor point information related to an available or desired amount of resources for coordinated UEs of the communicating point; and
a scheduler for adjusting at least one predetermined parameter related to the coordinated UEs based on the shared information so that the amount of resources for the coordinated UEs at the communicating point approaches the available or desired amount of resources for the coordinated UEs at the neighbor point.

15. The communicating point as set forth in claim 14, wherein the information sent from the neighbor point includes an available or desired amount of resources for the coordinated UEs at the neighbor point.

16. The communicating point as set forth in claim 14, wherein the information sent from the neighbor point includes an assigned or target amount of resources for UEs served by the neighbor point itself; and then the communicating point uses the information to estimate the available or desired amount of resources at the neighbor point for the coordinated UEs.

17. The communicating point as set forth in claim 14, wherein the information sent to the neighbor point includes a desired amount of resources for the coordinated UEs or a number of the coordinated UEs at the serving point; and the feedback information sent from the neighbor point includes a decision which is a result of comparing an available amount of resources at the neighbor point with the desired amount of resources included in the information sent from the communication point.

18. The communicating point as set forth in claim 14, wherein the information sent to the neighbor point at the beginning includes an initially desired amount of resources and the information sent thereafter includes a desired decrease of resources from the previous desired amount of resources for the coordinated UEs at the communicating point; and the feedback information sent from the neighbor point at the beginning includes a decision which is a result of comparing an available amount of resources at the neighbor point with the desired amount of resources, included in the information sent from the communicating point; and the feedback information sent from the neighbor point thereafter includes a decision which is a result of comparing an available amount of resources at the neighbor point with the calculated desired amount of resources, which is obtained by subtracting the desired decrease of resources, included in the information sent from the communicating point, from the previous desired amount of resources for the coordinated UEs.

19. The communicating point as set forth in claim 14, wherein the information sent to the neighbor point includes a desired increase of resources for the coordinated UEs at the communicating point; and the feedback information sent from the neighbor point includes a decision which is a result of comparing an available amount of resources at the neighbor point with the calculated desired amount of resources, which is obtained by adding the desired increase of resources, included in the information sent from the communicating point, to the previous desired amount of resources for the coordinated UEs.

20. A program stored in a recording medium provided in a communicating point which can communicate with other communicating points in a network, wherein the communicating point allocates resources to coordinated UEs which are supported by the communicating point as a serving point and are coordinated with a neighbor point, comprising:
sharing with the neighbor point information related to an available or desired amount of resources for coordinated UEs of the communicating point; and
adjusting at least one predetermined parameter related to the coordinated UEs based on the shared information so that the amount of resources for the coordinated UEs at the communicating point approaches the available or desired amount of resources for the coordinated UEs at the neighbor point.

21. A scheduling method for coordinated multi-point transmission/reception (CoMP) in a network including a plurality of communicating points which can communicate with each other, wherein coordinated UEs are supported by a serving point and are coordinated with a neighbor point, wherein:
the serving point communicates with the neighbor point to obtain information on an available or desired amount of resources for CoMP at the neighbor point; and
the serving point adjusts the amount of resources for CoMP so as to ensure the available or desired amount of resources for CoMP at the neighbor point.

22. The scheduling method according to claim 21, wherein the serving point and the neighbor point dynamically allocate resources to at least part of the coordinated UEs within an adjusted amount of resources for CoMP.

23. A scheduling method for coordinated multi-point transmission/reception (CoMP) in a network including a plurality of communicating points which can communicate with each other, wherein coordinated UEs are supported by a serving point and are coordinated with a neighbor point, wherein:
the neighbor point communicates with the serving point to obtain information on an available or desired amount of resources for CoMP at the serving point; and
the neighbor point compares the available or desired amount of resources for CoMP with its own resource condition and sends comparison information back to the serving point,
wherein the serving point adjusts the available or desired amount of resources for CoMP so as to satisfy the resource condition of the neighbor point.

24. The scheduling method according to claim 23, wherein the serving point and the neighbor point dynamically allocate resources to at least part of the coordinated UEs within an adjusted available or desired amount of resources for CoMP.
